(19) United States
(12) Patent Application Publication
(10) Pub. No.: US 2011/0097009 A1
(43) Pub. Date: Apr. 28, 2011

(54) DIGITAL IMAGE RESTORATION

(75) Inventor: Antoine Chouly, Paris (FR)

(73) Assignee: NXP B.V., Eindhoven (NL)

(21) Appl. No.: 13/000,341

(22) PCT Filed: Jun. 11, 2009
(86) PCT No.: PCT/IB2009/052500

§ 371 Date: Dec. 20, 2010

(30) Foreign Application Priority Data
Jun. 20, 2008 (EP) 08290590.2

(51) Int. Cl. G06K 9/40

(52) U.S. Cl. 382/260

(57) ABSTRACT

A method of restoring a digital image, the method comprising partitioning the image into a plurality of blocks of pixels, processing each block to produce a restored block and concatenating the restored blocks to produce a restored digital image, wherein the step of processing each block comprises: i) padding the block with additional pixels having values extrapolated from a range of pixel values across the block to produce a padded block; si) performing a Fourier transform operation on the padded block to produce a transformed block; iii) applying an inverse blur filler to the transformed padded block to produce a filtered block; and Iv) performing an inverse Fourier transform on the filtered block to obtain the restored block.

The invention relates to the field of digital image restoration, and in particular to techniques for de-blurring of digital images

Blur in images may be caused by various factors, including camera motion during exposure time (e.g., for low luminosity scenes) and the optical imaging system being out of focus. There are various known ways in which blurring may be identified, addressed and overcome or minimised, as for example described by Banham & Katsaggelos in “Digital image Restoration”, IEEE Signal Processing Mag. 14, pp 24-41, March 1997 and by Lagendijk & Biemond in “Basic Methods for Image Restoration and Identification”. Handbook of Image and Video Processing, Elsevier Academic Press, ed. Al Bovik, 2nd Edition, 2005.

Most prior frequency domain image restoration techniques require that an entire image is stored before starting the restoration process. This can lead to a long delay between image acquisition and processing, with processing requiring a large amount of device resources in terms of CPU load and memory. Moreover, such techniques are not suited to restoring images having spatially-variant (i.e. local) blurs, since processing is performed globally on the observed image.

An object of the invention is to address the above mentioned problems in order to optimise processes for restoring digital images reducing blurring.

In accordance with a first aspect of the invention, there is provided a method of restoring a digital image, the method comprising partitioning the image into a plurality of overlapping blocks of pixels, processing each block to produce a restored block and concatenating non-overlapping regions of the restored blocks to produce a restored digital image, wherein the step of processing each block comprises:
i) padding the block with additional pixels having values extrapolated from a range of pixel values across the block to produce a padded block;
ii) performing a Fourier transform operation on the padded block to produce a transformed block;
iii) applying an inverse blur filter to the transformed padded block to produce a filtered block; and
iv) performing an inverse Fourier transform on the filtered block to obtain the restored block.

An aim of the invention is to restore as closely as possible an accurate image of an original scene from a blurred image. Methods according to the invention have the advantages of lowering the delay between image acquisition and processing, and requiring less memory and CPU load than with known conventional processing techniques. The methods are therefore adaptable for low cost portable devices such as digital cameras. Furthermore, certain embodiments are capable of restoring images having spatially variant blurring.

The values of the additional pixels are optionally extrapolated linearly from pixel values on opposing edges of each block of the image. This ensures a smoother transition between adjacent block borders, and attenuates artifacts that may result from the Fourier transform.

Each padded block preferably consists of a square array of N×N pixels, with N being preferably equal to 2ⁿ, where n is an integer. This allows for a faster implementation of a 2D Fourier transform.

The step of applying an inverse blur filter optionally comprises multiplying each component of the transformed block by a corresponding component of the inverse blur filter.

The components Wᵤᵥ of the inverse blur filter are optionally determined according to:

$${W}_{uv} = \frac{{F}_{uv}^{*}}{{\vert {F}_{uv} \vert}^{2} + K}$$

where Fᵤᵥ are the frequency domain components of the blur filter, F*ᵤᵥ is the complex conjugate of Fᵤᵥ, and K is a constant. K is chosen according to an optimum balance between blur removal and visual artifacts in the restored image.

The components of the inverse blur filter are alternatively optionally determined according to:

$${W}_{uv} = \frac{{F}_{uv}^{*}}{{\vert {F}_{uv} \vert}^{2} + α {\vert {L}_{uv} \vert}^{2}}$$

where Fᵤᵥ are the frequency domain components of the blur filter, F*ᵤᵥ is the complex conjugate of Fᵤᵥ, α is a constant and Lᵤᵥ=4−2(cos(2πu/N)+cos(2πv/N)). Lᵤᵥ is a 2D Laplacian operator, which acts as a high-pass filter, and α is a tuning or regularization parameter. The restored image is thereby smoothed by attenuating its high frequency content, according to the degree of filtering applied by the scaled Laplacian operator.

An inverse blur filter is optionally determined for each block, thereby enabling spatially variant blurring in the image to be reduced. Alternatively, the same inverse blur filter is applied to each block, for example when applying the method to reduce spatially invariant blurring, i.e. blurring across each block in the digital image.

Optionally, in particular when processing images having spatially variant blurring, the plurality of overlapping blocks may together make up a selected portion of the digital image to be restored. Only the selected portion then needs to be processed according to the method, thereby reducing the overall processing time required.

Optionally, a plurality of portions of the digital image are each partitioned into respective pluralities of overlapping blocks of pixels, and the method performed on each of the plurality of portions of the digital image. This applies for example to situations where different portions of the image are blurred to different degrees.

The method is optionally performed separately on the luminance and chrominance components of the digital image. It is assumed throughout the description that the image is in YUV encoded format, although aspects of the invention may apply equally to other image encoding formats.

The method preferably comprises estimating a point spreading function from the digital image and determining the inverse blur filter from a Fourier transform of the point spreading function. The point spreading function may be estimated for each block, for example when dealing with spatially variant blurring.

The method in any or all aspects is preferably carried out by a suitably programmed computer or other electronic device.

In accordance with a second aspect of the invention, there is provided an electronic device comprising an image acquisition module and a processing module configured to perform the method of the first aspect of the invention.

The electronic device of the second aspect of the invention thereby comprises means for partitioning an acquired image into a plurality of overlapping blocks of pixels, means for processing each block to produce a restored block and concatenating non-overlapping regions of the restored blocks to produce a restored digital image, wherein the means for processing each block comprises:
i) means for padding the block with additional pixels having values extrapolated from a range of pixel values across the block to produce a padded block;
ii) means for performing a Fourier transform operation on the padded block to produce a transformed block;
iii) means for applying an inverse blur filter to the transformed padded block to produce a filtered block; and
iv) means for performing an inverse Fourier transform on the filtered block to obtain the restored block.

The invention is described in further detail below by way of example and with reference to the appended drawings, in which:

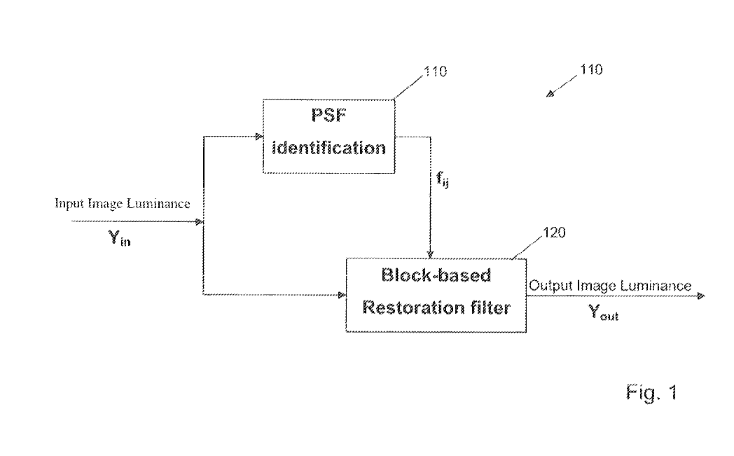

FIG. 1 is a flow diagram of a block based restoration method;

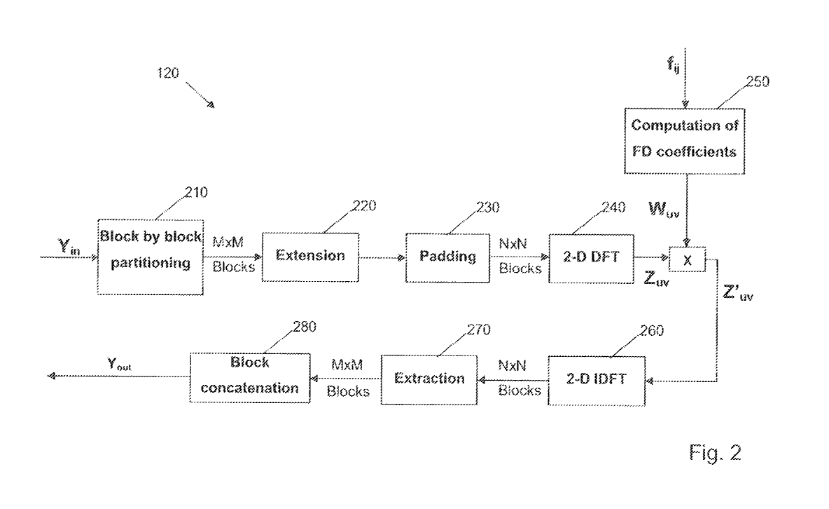

FIG. 2 is a flow diagram of the restoration filter of FIG. 1;

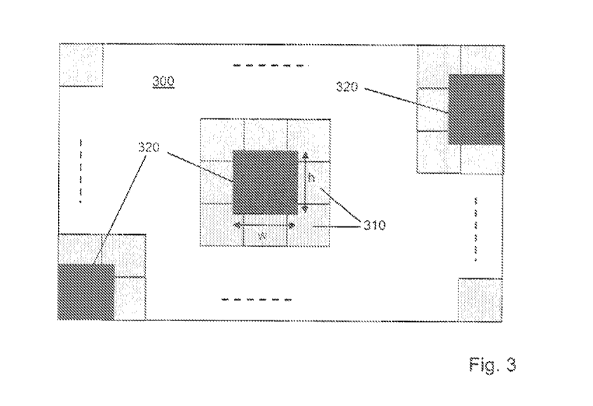

FIG. 3 is a schematic representation of a digital image divided into overlapping blocks;

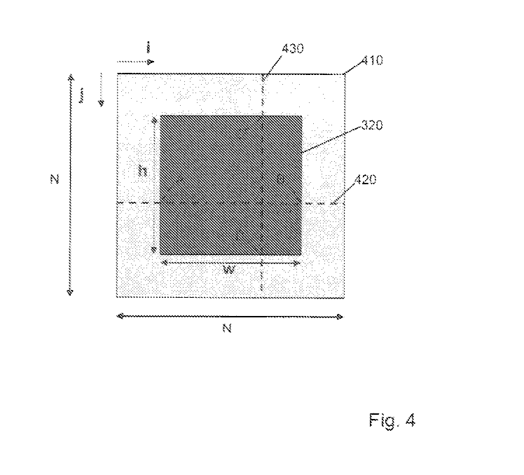

FIG. 4 is a schematic representation of padding of an overlapping block;

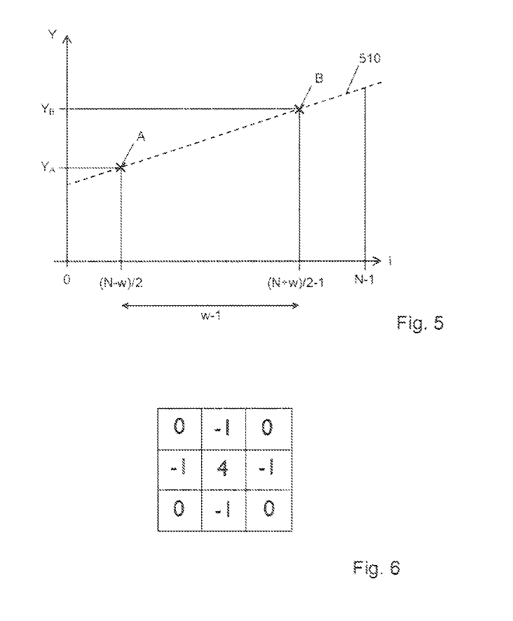

FIG. 5 is a schematic plot representing linear extrapolation of pixels in a row of a padded block;

FIG. 6 is a 2-D Laplacian operator;

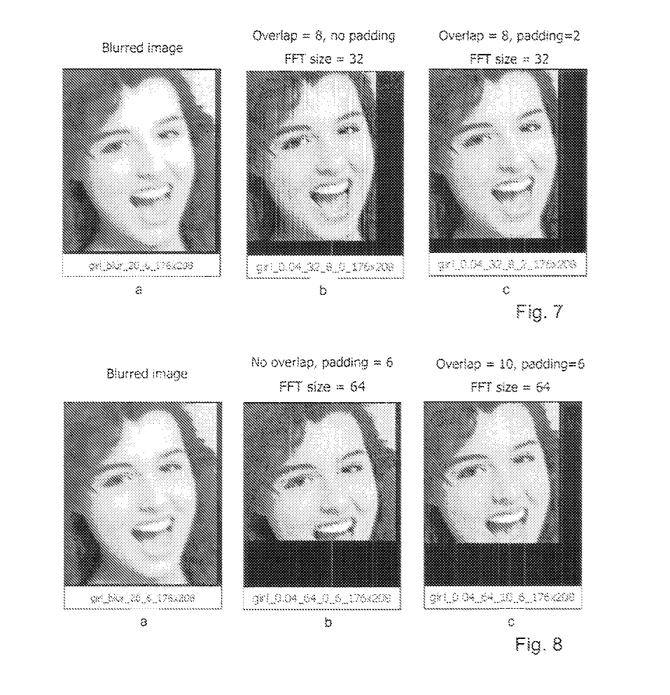

FIG. 7 is a series of digital images illustrating effect of different de-blurring processes; and

FIG. 8 is a further series of digital images illustrating the effect of different de-blurring processes.

The invention is concerned in general with the reconstruction or estimation of uncorrupted images from blurred and noisy images. Blurring in an image can be caused by relative motion between the camera and the original scene (particularly for dark scenes where exposure time is relatively long), or by an optical system that is out of focus.

A blurred image can be considered to result from the convolution of an original (i.e. ideal) image and a point spreading function (PST) fₖₗ. For the luminance component Y of a YUV image, the value of each pixel of the input (blurred) image Yin at a pixel position (i,j) is given by:

$${Yin}_{ij} = {\sum }_{k , l} {f}_{kl} \cdot {Yori}_{i - k , j - l} + {n}_{ij} \qquad [ 1 ]$$

where Yoriᵢⱼ is the luminance value of the original pixel (i,j) and nᵢⱼ is the noise that corrupts the blurred image. In the above equation, the PSF is assumed to be spatially invariant, i.e. the image is blurred in exactly the same way at every spatial location. In certain embodiments, the blurring may instead be spatially variant.

Similar equations can be written for the chrominance components of the digital image.

it is assumed that image deblurring can be carried out independently on the separate luminance component (Y) and chrominance components (U, V) of the digital image. Consequently, although the following sections relate only to the luminance component, it is to be understood that corresponding methods can be applied to the other components of the digital image.

As illustrated in the flow diagram of FIG. 1, the overall method 100 comprises two general processes 110, 120 that together arrive at an estimate of the original image from a degraded or blurred image. Each process 110, 120 is performed on the observed image Yᵢₙ. A degree of blur in the image is identified by identifying 110 a point spreading function from the image, and a bock based restoration filter is applied 120 to the image using frequency coefficients fᵢⱼ of the identified point spreading function. An output image Yₒᵤₜ is then produced.

The overall goal of the method 100 is to perform an operation on the degraded image Yᵢₙ that is a better approximation of the inverse of the imperfections in the image formation system through use of an estimated PSF.

The following sections describes a block-based method (corresponding to process 120 of FIG. 1) for image restoration. It will be assumed that the PSF coefficients fᵢⱼ are perfectly estimated during the blur identification process 110, in reality, estimates will be obtained of the PSF, for example through use of the techniques described and referenced in Banham & Katsaggelos (cited above).

FIG. 2 shows a flow diagram of an exemplary block-based deblurring process 120 comprising the steps of image partitioning, padding, Fourier transformation, frequency domain filtering, inverse Fourier transformation and block extraction. Each of these steps is detailed by example in the following sections.

### Image Partitioning

The blurred image Yᵢₙ is partitioned (step 210) into blocks of size M×M, where M depends on the PSF length. Each block is extended by a number of pixels, a, on each side (right, left, top and bottom), where a side adjoins an adjacent block, as depicted in FIG. 3. Sides of blocks along the outer edges of the image are not extended. Thus, the resulting overlapped block width w and height h is equal to M+2a for inner blocks and to M+a for blocks located on the vertical or horizontal edge of the image. The block size M is preferably significantly greater than the PSF length, The overlap, a, is also preferably higher than the PSF. Exemplary values for a PSF length of less than 20 pixels are: N=256, a=32, M=128 or 160, resulting in 32 or 16 padded pixels on each side.

The blocks are preferably square, i.e. of dimensions M×M, since blocks before the FFT process are also square (N×N) except for those iodated at the right and bottom border of the image. If the image width is not a multiple of M, then the block size at the right border is M′+M, where M′ is the image width, modulo M. For these blocks, the overlap will be a pixels at the left side of the block, but more pixels can be padded in the horizontal direction so that the final size is N.

Similarly, for blocks along the bottom border, the size is N×M″, where M″ is the image height, modulo M. More pixels can be padded in the vertical direction so that the final size is N.

Following the above, the corner block (right bottom) has a size of M′×M″, and can therefore be padded with additional pixels along both the right and bottom edges.

The subsequent processes of padding, transformation, filtering, inverse transformation and extraction, depicted as steps 230, 240, 260, 270 and 280 in FIG. 2, are performed independently on each block.

### Padding

FIG. 3 illustrates schematically a partitioned image 300, the image 300 being divided into a plurality of blocks 310. Each block 310 is treated as an overlapping block 320 having a width w and height h.

Each overlapping block 320 is then padded by linearly extrapolating pixel values on opposing sides of the block 320, as illustrated in FIG. 4. The resulting square block 410 is of size N×N pixels. N being preferably chosen to be a power of two (i.e. N=2ⁿ, where n is an integer), so that a fast implementation of a discrete Fourier transform (DFT) can be used in subsequent processing.

The step of padding ensures a more smooth transition between adjacent block borders, thereby attenuating any artifacts generated due to a periodicity inherent in the DFT process. In the following example, each row 420 in the overlapped block 320 is extrapolated by N−w pixels (i.e. by (N−w)/2 pixels on each side), and each column 430 is extrapolated by N−h pixels.

The following equation provides the values of padding pixels Yᵢ for each row 420:

$${Y}_{i} = {Y}_{A} + ( i - \frac{N - w}{2} ) \cdot \frac{( {Y}_{B} - {Y}_{A} )}{( w - 1 )} , \\ for i = 0 , … , \frac{N - w}{2} - 1 , \frac{N + w}{2} , … , N - 1 \qquad [ 2 ]$$

where Y_{A} and Y_{B} are the luminance values at pixels A and B respectively and Yⁱ is the linearly extrapolated luminance value at the i^{th} pixel of row 420 (i=0 corresponding to the first, or leftmost, pixel of the row 420).

Similarly, each column 430 of length h is padded symmetrically with (N−h)/2 pixels on each side, with the values of each padding pixel Yⱼ of the column 430 provided by:

$${Y}_{j} = {Y}_{C} + ( j - \frac{N - h}{2} ) \cdot \frac{( {Y}_{D} - {Y}_{C} )}{( h - 1 )} , \\ for j = 0 , … , \frac{N - h}{2} - 1 , \frac{N + h}{2} , … , N - 1 \qquad [ 3 ]$$

where Y_{C} and Y_{D} are the luminance values at pixels C and D respectively and Yⱼ is the linearly extrapolated luminance value at the j^{th} pixel of the column 430 (j=0 corresponding to the first, or topmost, pixel of the column 430).

The process of extrapolation is illustrated in FIG. 5, which shows a plot of luminance Y as a function of pixel position i across a row 420 of a padded block 410. The pixels A and B, having luminance values Y_{A} and Y_{B} respectively, are extrapolated according to equation 2 above, which defines the relationship indicated by dotted line 510.

Extrapolation is carried out in two steps, first for horizontal (or vertical) padding, and second for vertical (or horizontal) padding. For each row, a pixels are padded on each side of the block. The number of padded rows is h and the resulting block has a size of N×h. For each column of the N×h block, a pixels are then padded on each side (top and bottom). The number of padded columns is N and the resulting block has a size of N×N. For the preferred case of linear extrapolation, the same result is obtained if vertical padding is instead performed before horizontal padding. Other non-linear extrapolation methods may alternatively be used, but linear extrapolation is generally preferred due to its simplicity.

Each pixel value is rounded to an integer and clipped to fit between the limits of an allowable range. For example, if each pixel is encoded according to an 8-bit scheme, the extrapolated values above are rounded to integers and clipped between 0 and 255, i.e. any values above 255 resulting from the above equations are made to equal 255 and any values below 0 are made to equal 0.

### 2D Transformation

For each padded block resulting from the above process, a 2-D fast Fourier transform (FFT) is performed. A complex-valued output block is produced, denoted by Zᵤᵥ where u=0, . . . , N−1, v=0, . . . , N−1, u and v being the horizontal and vertical frequency components. The 2-D FFT can be computed by first computing a 1-D FFT along each row 420 of the input block 410, and then computing a 1-D FFT along each column of the resulting intermediate block.

### Frequency Domain Filtering

This step can be achieved by multiplying each frequency component Zᵤᵥ by a a filtering coefficient Wᵤᵥ, according to the following equation:

Z′ᵤᵥZᵤᵥ·Wᵤᵥ for u=0, . . . , N−1 and v=0, . . . , N−1 [4]

The coefficients Wᵤᵥ correspond to an approximation of the inverse blur filter (PSF) in the frequency domain and depend on the PSF fᵢⱼ (FIG. 2) as:

$${W}_{uv} = \frac{{F}_{uv}^{*}}{{\vert {F}_{uv} \vert}^{2} + K} \qquad [ 5 ]$$

where F*ᵤᵥ is the complex conjugate of Fᵤᵥ, K is a constant and Fᵤᵥ is the PSF spectrum (i.e. the DFT of fᵢⱼ). An optimal value of K is chosen as a result of a trade-off between blur removal and visual artifacts due to ringing and noise enhancement (K=0 corresponds to the inverse filter). An exemplary range of values for K would be between around 0.01 and 0.1, the higher end of this range being more suitable for noisy images and the lower end for images with low noise.

An method for computing Wᵤᵥ consists of replacing K by a high pass filter, according to the following equation:

$${W}_{uv} = \frac{{F}_{uv}^{*}}{{\vert {F}_{uv} \vert}^{2} + α {\vert {L}_{uv} \vert}^{2}} \qquad [ 6 ]$$

where Lᵤᵥ=4−2(cos(2πu/N)+cos(2πv/N)), Lᵤᵥ being a 2-D Laplacian operator (a high-pass filter, whose PSF is given in FIG. 6), and α is a tuning or regularization parameter similar to the constant K and having broadly the same range of values. This allows for smoothing of the deblurred image through attenuation of high frequency components.

For spatially invariant blurs (i.e. where the PSF is the same over all the image), the coefficients Wᵤᵥ can be computed once before starting the restoration process on each block. Otherwise, for spatially variant blurring, the coefficients Wᵤᵥ can be computed for each block, or for subsets of blocks making up regions of the image where blurring is spatially invariant.

### 2-D Inverse Transformation

The luminance component of the restored N×N block resulting from process 260 of the method (FIG. 2) is retrieved by applying a 2-D inverse FFT (IFFT) on the N×N block Z′ᵤᵥ, for u=0, . . . , N−1 and v=0, . . . , N−1. As for the FFT process 240. The 2-D IFFT can be computed along each row of the block, and then along each column.

### Block Extraction

In this step (step 270 of FIG. 2), an M×M restored block is obtained by taking the real part of the N×N block output from the IFFT process 260 (after rounding to integer values and clipping to between a desired range, e.g. between 0 and 255 for 8-bit encoding) and keeping the useful part of the block, of size M×M.

Finally, the M×M restored blocks are concatenated (step 280) to form the output image Yₒᵤₜ (for the luminance component). As explained above, similar processes can be applied to the other components of the image.

FIGS. 7 and 8 illustrate the influence of overlapping and padding on visual quality after image restoration on a blurred original image. The cropped areas in FIGS. 7b&c and 8b&c are features of the original image having pixel dimensions not being an integer multiple of the chosen block size, which can be addressed by the use of additional padding pixels as described above.

In FIG. 7, the blurred image (FIG. 7a) is processed using an overlap of 8 pixels and with no padding, resulting in the image of FIG. 7b, and processed with an overlap of 8 pixels and as padding of 2 pixels, resulting in the image of FIG. 7c. Both processed images used an FFT size of 32. The use of padding leads to a significant reduction of image artifacts compared to when no padding is used. Padding therefore considerably improves the image quality after restoration, by reducing the high frequency components generated by border discontinuities due to the periodicity of the Fourier transform.

in FIG. 8, the blurred image (FIG. 8a) is processed using non-overlapping blocks, resulting in the restored image of FIG. 8b, and using an overlap of 10 pixels, resulting in the restored image of FIG. 8c. Both processes used a padding of 6 pixels and an FFT size of 64. The use of overlapping blocks significantly reduces visible block artifacts in the restored image.

Certain embodiments allow for adaptive processing, e.g., when some image objects are out-of-focus while others are in focus, resulting in spatially variant blurring. As described above, different coefficients Wᵤᵥ can be used for different regions of a blurred image, or even for each different block in the image.

The deblurring process can begin during image acquisition, provided that an appropriate blur model or PSF is known beforehand. This can reduce delay or latency in processing images.

Only a part of the image needs to be stored in memory during processing, thereby reducing memory requirements. The use of blocks rather than the whole image also reduces complexity of the restoration process.

Image quality is an increasingly important feature for portable devices (such as PDAs, mobile phones, etc) with digital imaging facilities, where processing power is necessarily limited by comparison with conventional general purpose computers. The proposed method, in allowing for efficient compensation for blurring, allows such devices to minimise on use of resources such as memory and CPU load.

A further aspect of the invention is therefore a electronic device comprising an image acquisition module, which may include a camera unit, and image processing components configured to perform the method according to the embodiments described above. The electronic device may be portable, for example in the form of a hand-portable unit such as a mobile phone.

Other embodiments are also intended to be within the scope of the invention, as defined by the appended claims.

1. A method of restoring a digital image, the method comprising:
partitioning the image into a plurality of blocks of pixels,
processing each block to produce a restored block and
concatenating the restored blocks to produce a restored digital image,
wherein the step of processing each block comprises:
padding the block with additional pixels having values extrapolated from a range of pixel values across the block to produce a padded block;
performing a Fourier transform operation on the padded block to produce a transformed block;
applying an inverse blur filter to the transformed padded block to produce a filtered block; and
performing an inverse Fourier transform on the filtered block to obtain the restored block.

2. The method of claim 1 wherein the values of the additional pixels are linearly extrapolated from pixel values on opposing edges of the block.

3. The method of claim 1 wherein the padded block is a square array of N×N pixels.

4. The method of claim 3 wherein N=2n, where n is an integer.

5. The method of claim 3 wherein the step of applying an inverse blur filter comprises multiplying each component of the transformed block by a corresponding component of the inverse blur filter.

6. The method of claim 5 wherein the components Wᵤᵥ of the inverse blur filter are determined according to:
$${W}_{uv} = \frac{{F}_{uv}^{*}}{{\vert {F}_{uv} \vert}^{2} + K}$$
where Fᵤᵥ are the frequency domain components of the blur filter, F*ᵤᵥ is the complex conjugate of Fᵤᵥ, and K is a constant.

7. The method of claim 5 wherein the components of the inverse blur filter are determined according to:
$${W}_{uv} = \frac{{F}_{uv}^{*}}{{\vert {F}_{uv} \vert}^{2} + α {\vert {L}_{uv} \vert}^{2}}$$
where Fᵤᵥ are the frequency domain components of the blur filter, F*ᵤᵥ is the complex conjugate of Fᵤᵥ, is a constant and Lᵤᵥ=4−2(cos(2πu/N)+cos(2πv/N)).

8. The method of claim 1 wherein an inverse blur filter is determined for each block.

9. The method of claim 1 wherein the same inverse blur filter is applied to each block.

10. The method of claim 1 wherein the plurality of blocks together make up a selected portion of the digital image to be restored.

11. The method of claim 10 wherein a plurality of portions of the digital image are each partitioned into respective pluralities of blocks of pixels, the method being performed on each of the plurality of portions of the digital image.

12. The method of claim 1 wherein the method is performed separately on luminance and chrominance components of the digital image.

13. The method of claim 1 further comprising estimating a point spreading function from the digital image and determining the inverse blur filter from a Fourier transform of the point spreading function.

14. The method of claim 13 wherein the point spreading function is estimated for each block.

15. The method of claim 1 wherein the digital image is partitioned into a plurality of overlapping blocks, the restored image being produced by concatenating non-overlapping regions of the restored blocks.

16. A computer program for instructing a computer to perform the method of claim 1.

17. A computer-readable medium comprising computer program product code according to claim 16.

18. An electronic device comprising an image acquisition module and a processing module configured to perform the method of claim 1.
